(19) United States
(12) Patent Application Publication
(10) Pub. No.: US 2014/0004738 A1
(43) Pub. Date: Jan. 2, 2014

(54) POLE TERMINAL

(71) Applicants: Wolfgang B. Thoerner, Essen (DE); Christian Paul, Oer-Erkenschwick (DE)

(72) Inventors: Wolfgang B. Thoerner, Essen (DE); Christian Paul, Oer-Erkenschwick (DE)

(21) Appl. No.: 13/977,947

(22) PCT Filed: Jan. 3, 2012
(86) PCT No.: PCT/EP2012/000008

§ 371 Date: Sep. 11, 2013

(30) Foreign Application Priority Data
Jan. 3, 2011 (DE) 10 2011 007 940.8

(51) Int. Cl. H01R 13/641

(52) U.S. Cl. CPC H01R 13/641
USPC 439/578

(57) ABSTRACT

The invention relates to a pole terminal (3) for establishing an electrical line connection, comprising a main body (20) and a clamping nut (1) that can be screwed onto the main body (20), wherein a conductor element to be connected to the pole terminal (3) can be pressed against a contact element (5) of the pole terminal (3) by means of the clamping nut (1). In order to provide a novel pole terminal (3) that can indicate to a user of the pole terminal whether an electrical line connection of desired quality has been established, the pole terminal (3) has an indicating element (2), by means of which it can be indicated whether an electrical connection of certain quality is established between the conductor element and the contact element (5), wherein the indicating element (2) responds immediately to the pressing force that is produced by the clamping nut (1) and by means of which the conductor element is pressed against the contact element (5).

The invention relates to a pole terminal for establishing an electrical line connection, comprising a main body and a clamping nut that can be screwed onto the main body, wherein a conductor element to be connected to the pole terminal can be pressed against a contact element of the pole terminal.

Pole terminals are utilized to a large extent in consumer electronics to couple lines and particularly loudspeakers to amplifiers. Pole terminals are distinguished by the fact that they allow for easy manual coupling and uncoupling.

It is the object of the present invention to provide a novel pole terminal that can indicate to a user of the pole terminal whether an electrical line connection of desired quality has been established.

This object is achieved based on a pole terminal of the type mentioned hereinabove in that the pole terminal has an indicating element, by means of which it can be indicated whether an electrical connection of certain quality is established between the conductor element and the contact element, wherein the indicating element responds immediately to the pressing force that is produced by the clamping nut and by means of which the conductor element is pressed against the contact element.

The invention is based on the recognition that the pressing force by means of which the conductor element is pressed against the contact element constitutes the decisive variable for the quality of an electrical line connection. For example, if the conductor element is pressed against the contact element with a too low pressing force, only an insufficient electrical line connection is established. The electrical transition resistance between the conductor element and the contact element is too high and causes an attenuation of the electrical signals transmitted via the electrical line connection. If it is intended to prevent this, then the pressing force must be adjusted optimally. To enable a user of a pole terminal to evaluate the pressing force and/or the quality of the electrical line connection thus prompted when operating the pole terminal, it is required to give an appropriate feedback to the user. This is inventively accomplished by means of the indicating element.

The present invention differs in particular from those mechanisms in which a torque limitation is allocated to the clamping nut which like a torque wrench only allows for a certain maximum torque when screwing-on the clamping nut. The inventive indicating element does not respond to the torque, but immediately to the pressing force which constitutes a more direct and more reliable measure for the quality of an electrical line connection. Unlike in case of a torque limitation, the user of the inventive pole terminal has the option to arbitrarily increase the pressing force, even after the indicating element has indicated an electrical connection of a certain quality between the conductor element and the contact element.

In accordance with an advantageous embodiment of the present invention, the indicating element is so configured that it generates a sensible, audible or visible signal when the pressing force exceeds a definable or firmly definable design pressing force. This signal indicates whether an electrical connection of a certain quality has been established between the conductor element and the contact element.

In accordance with another advantageous embodiment of the present invention, the indicating element causes an erratic, i.e. clearly sensible increase of the torque required for screwing-on the clamping nut, when the pressing force exceeds the design pressing force. Thus, on exceeding the design pressing force, the indicating element generates a sensible signal which indicates whether an electrical connection of a certain quality has been established between the conductor element and the contact element.

Another advantageous embodiment of the present invention provides for that the indicating element arranged between the clamping nut and the contact element is a composite material component comprised of a hard pressing ring (e.g. made of hard plastic like polyamide) facing the clamping nut and an attenuator ring made of elastic material (e.g. rubber or polyurethane or another elastomer material) facing the contact element, wherein part of the material of the attenuator ring partly penetrates the pressing ring, which means that this part of the material of the attenuator ring penetrates the pressing ring starting from the pressing ring side facing the contact element via part of the axial longitudinal extension of the pressing ring in the direction of the clamping nut.

In accordance with another advantageous embodiment of the present invention, the attenuator ring is so deformed as the pressing force increases that part of the material of the attenuator ring flows through the pressing ring in the direction of the clamping nut so that the attenuator ring when having reached the design pressing force enters into a contact with the clamping nut. Until reaching the design pressing force, the attenuator ring has no contact with the clamping nut. From the moment when the design pressing force in the direction of the clamping nut has been reached, the deformed attenuator ring protrudes beyond the rim of the pressing ring. Until the design pressing force is reached, the material lies back behind the clamping nut side rim of the pressing ring so that it cannot contact the clamping nut. To enable a flow of material of the attenuator ring through the pressing ring in the direction of the clamping nut, axially orientated channels are preferably arranged at the outer surface of the pressing ring, said channels being interspersed with the material of the attenuator ring. The flow process is preferably reversible so that when loosening the clamping nut the portion of material that has flown through the pressing ring retreats back from the pressing ring in the direction of the contact element.

It is furthermore proposed that a spin lock preventing a self-acting unscrewing of the clamping nut is provided by the contact between the attenuator ring and the clamping nut. To this effect, the materials for the clamping nut and for the attenuator ring shall be properly chosen to ensure sufficient adhesion friction between them. The spin lock particularly prevents the clamping nut of a pole terminal arranged at a loudspeaker from getting loose or being detached unintentionally due to vibrations occurring while operating a loudspeaker.

In accordance with another advantageous embodiment of the present invention, knobs are arranged on the attenuator ring surface facing the contact element. Hereby it is prevented that adhesive bonding occurs between the attenuator ring and the contact element after extensive use of the pole terminal which would make it more difficult to detach the electrical line connection.

In accordance with another advantageous embodiment of the present invention, the pole terminal has a locking ring which is arranged on the attenuator ring and which partly surrounds it. The fact that the locking ring partly surrounds the attenuator ring should mean that the locking ring only extends over part of the axial longitudinal extension of the attenuator ring. In particular, the attenuator ring end facing the contact element is not surrounded by the locking ring. The arrangement of the locking ring at the attenuator ring limits the expandability of the material of the attenuator ring in radial direction as the deformation of the attenuator ring increases. Moreover, a ring gap is configured between the locking ring and the pressing ring in which the (accordingly ring-shaped) section of the attenuator ring which gets in contact with the clamping nut can controllably move in axial direction if the material of the attenuator ring flows through the pressing ring when tightening the clamping nut.

In accordance with another advantageous embodiment of the present invention, an interlocking is arranged at the locking ring surface facing the clamping nut, said interlocking getting in contact with the clamping nut when screwed on in order to provide a further spin lock. Preferably at least one projection is configured at the clamping nut surface facing the contact element, said projection co-acting with the interlocking. The effect of this further spin lock corresponds to that of the spin lock described hereinabove. These two spin locks may supplement each other to create a high-grade connection in which a self-acting loosening or detachment is nearly impossible.

Furthermore it is proposed that the locking ring is comprised of an at least partly transparent material. Through a thus configured locking ring, the attenuator ring material existing between the locking ring and the pressing ring in the ring gap or in the axial channels of the pressing ring can be recognized. Based on the deformation of the material of the pressing ring, a user can also optically recognize the status of reaching the design pressing force through the locking ring. Eligible as material for the transparent locking ring is, for example, polycarbonate.

Other features and advantages of the present invention are elucidated in the following by way of practical examples shown in these figures, where:

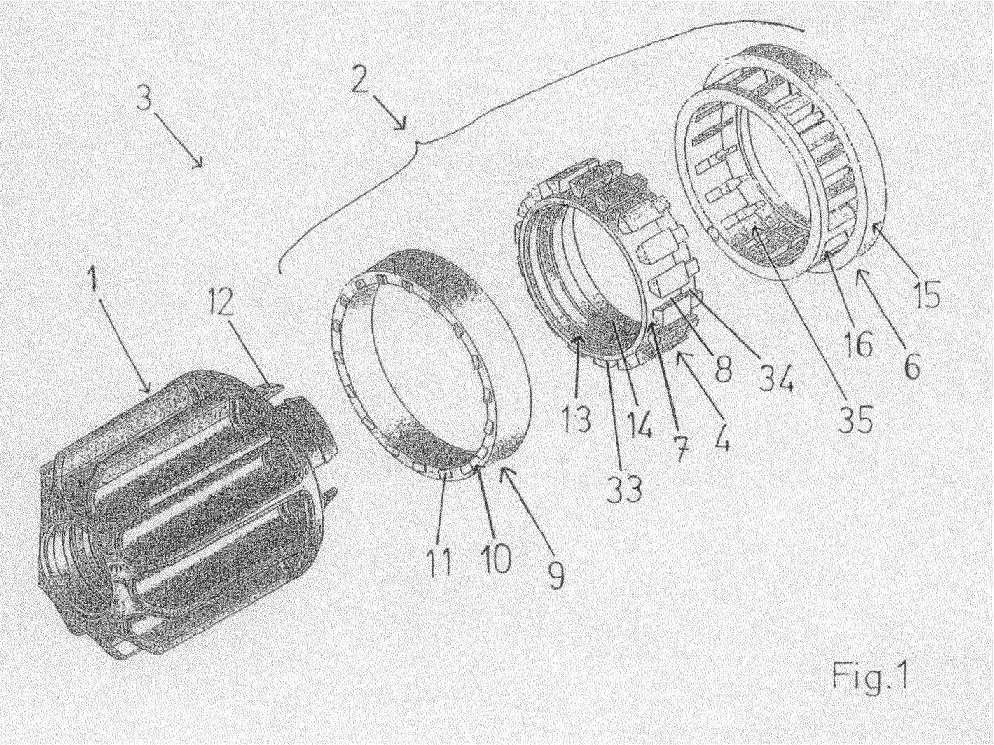

FIG. 1: shows a perspective exploded view drawing of a practical example of the clamping nut and the indicating element,

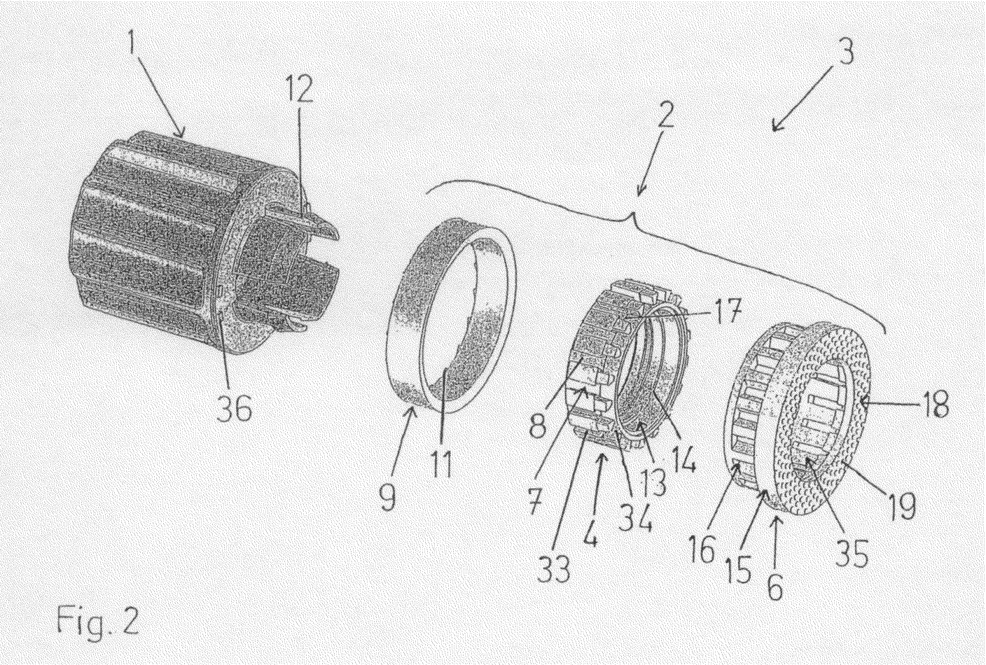

FIG. 2: shows another perspective exploded view drawing of the practical example shown in FIG. 1,

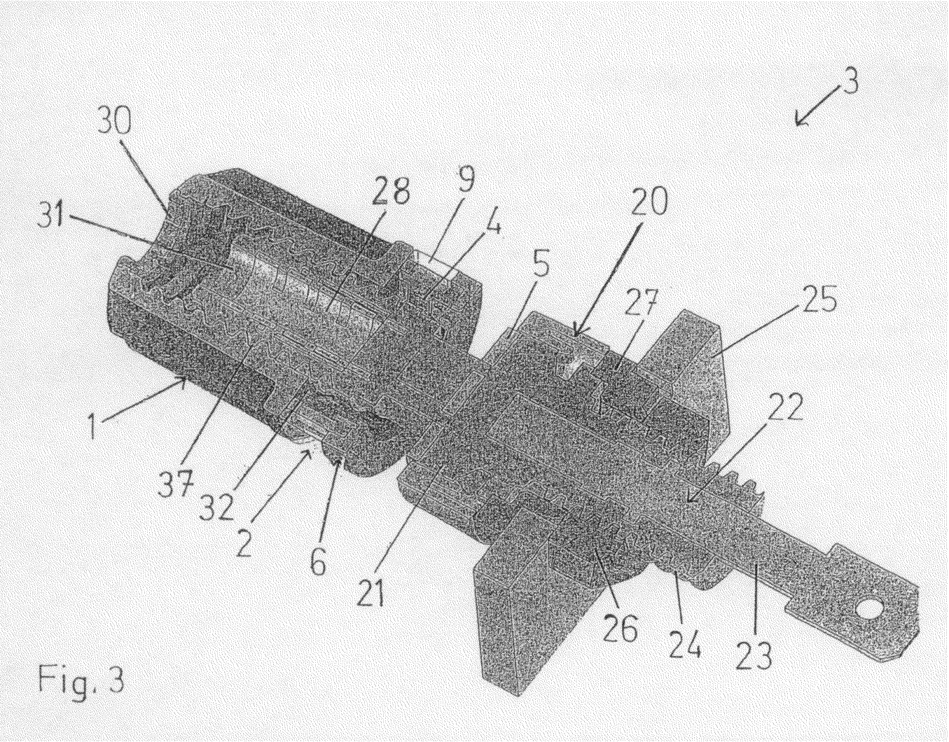

FIG. 3: shows a perspective representation of a longitudinal section through an exemplary embodiment of the inventive pole terminal, and

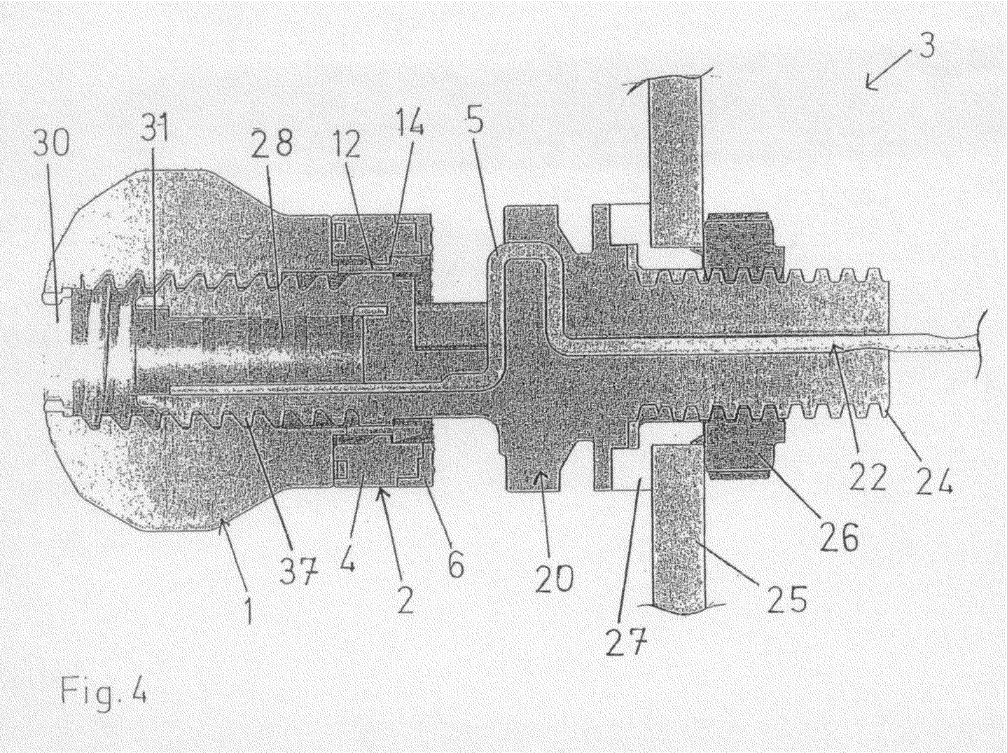

FIG. 4: shows a longitudinal section through an alternative embodiment of the inventive pole terminal.

FIG. 1 in a perspective shows an exploded view drawing of a clamping nut 1 and an indicating element 2 of the inventive pole terminal 3 shown in FIG. 3. The indicating element 2 is configured as a composite material component. It has a hard pressing ring 4 facing the clamping nut 1, an attenuator ring 6 made of an elastic material and facing the contact element 5 shown in FIG. 3 as well as a locking ring 9.

Axial orientated channels 8 through which part of the material of the attenuator ring 6 can flow are provided at the outer surface 7 of the pressing ring 4. Circumferentially arranged at the inner surface 13 of the pressing ring 4 is a projection 14 which co-acts with snap projections 12 at the clamping nut 1 to configure a snap connection. The pressing ring 4 furthermore has two axially adjacent sections 33 and 34, wherein the outer diameter of the section 34 facing the attenuator ring 6 is smaller than the outer diameter of the section 33 facing the clamping nut 1.

Arranged at the surface 10 of the locking ring 9 facing the clamping nut 1 is an interlocking 11 which can be brought in contact with the clamping nut 1 to configure a spin lock. The locking ring 9 is formed of an at least partly transparent material.

The attenuator ring 6 also has two axially adjacent sections 15 and 16, wherein the outer diameter of the connecting section 16 facing the clamping nut 1 is smaller than the outer diameter of the pressing section 15 facing the contact element 5. The contour of the inner surface 35 of the attenuator ring 6 is adapted to the contour of the outer surface 7 of the pressing ring 4.

The indicating element 2 is so composed that the connecting section 16 of the attenuator ring 6 is applied at least up to the circumferential section 17 between the two sections 33 and 34 onto the pressing ring 4 and that the locking ring 9 is arranged at the connecting section 16 in a way that it surrounds it. The indicating element 2 thus formed can be connected via the afore-mentioned snap connection with the clamping nut 1 to form a unit. If a defined design pressing force is exceeded by turning the clamping nut 1, the material of the attenuator ring 7 and/or the material of its connecting section 16 can flow in the direction of the clamping nut 1 and further through the channels 8 at the pressing ring 4. Then it becomes recognizable as a visible signal of the indicating element 2 to a user of the pole terminal 3 through the locking ring 9 made of a transparent material.

FIG. 2 shows the practical example shown in FIG. 1 for the clamping nut 1 and the indicating element 2 from a different perspective. Knobs 19 are formed at the attenuator ring 6 surface 18 facing the contact element 5. These prevent an adhesive bonding of the attenuator ring 6 and contact element 5. Provided for at the clamping nut 1 surface 32 facing the indicating element 2 are snap projections 36 which co-act with the interlocking 11 at the locking ring 9 to provide a spin locking.

FIG. 3 perspectively shows a longitudinal section thorugh a practical example for the inventive pole terminal 3 for establishing an electrical line connection. The pole terminal 3 has a main body 20 onto which the clamping nut 1 is screwed on.

The main body 20 has an insulating body 21, in which a conductor body 22 is arranged. On its device side, the insulating body 21 is provided with a thread 24. Via this thread 24, the pole terminal 3 can be fastened to a wall 25 of a casing of a loudspeaker, said casing not shown here more closely, and to this effect the pole terminal 3 has a nut 26 made of insulating material which can be screwed onto the thread 24. Moreover, a bearing ring 27 made of an insulating material is provided for which allows for a position-precise bearing of the pole terminal 3 at the casing. At its opposite end, the insulating body 21 also has a male thread 37 onto which the clamping nut 1 is screwed on.

At its side facing the casing, the conductor body 22 terminates in a section 23 configured as a soldering lug and not surrounded by the insulating body 21 which serves for connecting a loudspeaker line not shown here. The conductor body 22 has a contact surface running transversely to the longitudinal axis of the pole terminal 3, said contact surface being formed by the side of the contact element 5 facing the clamping nut 1. Furthermore, the conductor body 22 has a ring-shaped contact surface 28 arranged in parallel to its longitudinal axis, said contact surface serving for connecting a banana plug or the like not shown here which can be introduced through an opening 30 in the clamping nut 1 and an opening 31 in the insulating body 21 into the pole terminal 3.

By turning the clamping nut 1, it can be moved towards the contact element 5. During this procedure, the indicating element 2 is simultaneously moved towards the contact element 5. After the attenuator ring 6 has come into contact with the contact element 5, a pressing force is generated by another turn of the clamping nut 1. As the pressing force increases, the attenuator ring 6 is so deformed that part of the material of the attenuator ring 6 flows through the pressure ring 4 and/or through the channels 8 of the pressure ring 4 in the direction of the clamping nut 1 and gets in contact with the clamping nut 1 and/or its side 32 facing the indicating element 2 when the definable design pressing force is reached. This contact between the material of the attenuator ring 6 and the clamping nut 1 causes an erratic increase of the torque required for screwing-on the clamping nut 1. To a user of the pole terminal 3, it represents a sensible signal which indicates that an electrical connection of a certain quality has been established between the not-shown conductor element, for example an insulated cable strand, and the contact element 5. The indicating element 2 thus responds immediately to the pressing force producible by the clamping nut 1 by way of which the not shown conductor element is pressed against the contact element 5. At the same time, the indicating element 2 emits a visible signal through the transparent configuration of the locking ring 9 which like the sensible signal indicates an electrical connection of a certain quality between the not shown conductor element and the contact element 5.

FIG. 4 shows an alternative embodiment for the inventive pole terminal 3 in a longitudinal section. A significant difference between this practical example and the one shown in FIGS. 1 to 3 rests in that the indicating element 2 has no to locking ring 9, but is merely formed by the pressing ring 4 and the attenuator ring 6. Owing to this configuration of the pole terminal 3, the indicating element 2 merely emits a sensible signal when the pressing force exceeds a definable design pressing force, i.e. in such a way that an erratic increase of the torque required for screwing-on the clamping nut 1 is caused when the pressing force exceeds the definable design pressing force.

The practical examples described by way of these figures serve for explanation and are not restrictive.

1. Pole terminal (3) for establishing an electrical line connection, comprising a main body (20) and a clamping nut (1) that can be screwed onto the main body (20), wherein a conductor element to be connected to the pole terminal (3) can be pressed against a contact element (5) of the pole terminal (3),
wherein
an indicating element (2), by means of which it can be indicated whether an electrical connection of certain quality is established between the conductor element and the contact element (5), wherein the indicating element (2) responds immediately to the pressing force that is produced by the clamping nut (1) and by which the conductor element is pressed against the contact (5).

2. Pole terminal (3) according to claim 1, wherein the indicating element (2) is so configured that it generates a sensible, audible, or visible signal when the pressing force exceeds a design pressing force.

3. Pole terminal (3) according to claim 2, wherein the indicating element (2) causes an erratic increase of the torque required for screwing-on the clamping nut (1) when the pressing force exceeds the design pressing force.

4. Pole terminal (3) according to claim 1, wherein the indicating element (2) arranged between the clamping nut (1) and the contact element (5) is a composite material component which is comprised of a hard pressing ring (4) facing the clamping nut (1) and an attenuator ring (6) facing the contact element (5) made of elastic material, wherein part of the material of the attenuator ring (6) partly penetrates through the pressing ring (4).

5. Pole terminal (3) according to claim 4, wherein the attenuator ring (6) is so deformed as the pressing force rises that part of the material of the attenuator ring (6) flows through the pressing ring (4) in the direction of the clamping nut (1) so that the attenuator ring (6) gets in contact with the clamping nut (1) as the design pressing force is reached.

6. Pole terminal (3) according to claim 5, wherein axially orientated channels (8) are configured at the external surface (7) of the pressing ring (4), said channels being interspersed with part of the material of the attenuator ring (6).

7. Pole terminal (3) according to claim 5, wherein the contact between the attenuator ring (6) and the clamping nut (1) provides a spin lock which prevents self-acting unscrewing of the clamping nut (1).

8. Pole terminal (3) according to claim 4, wherein knobs (19) are configured on the surface (18) of the attenuator ring (6) which faces the contact element (5).

9. Pole terminal (3) according to claim 4, comprising a locking ring (9) which is arranged at the attenuator ring (6) and which partly surrounds it.

10. Pole terminal (3) according to claim 9, wherein an interlocking (11) is arranged at the locking ring (9) surface (10) facing the clamping nut (1), said interlocking entering into a contact with the clamping nut (1) when screwed-on in order to configure another spin lock.

11. Pole terminal (3) according to claim 9wherein the locking ring (9) is comprised of an at least partly transparent material.
